(19) United States
(12) Patent Application Publication
(10) Pub. No.: US 2003/0173221 A1
(43) Pub. Date: Sep. 18, 2003

(54) Geosynthetic structure

(76) Inventor: Colin John Francis Philip Jones, New Castle Upon Tyne (GB)

Correspondence Address: JACOBSON HOLMAN PLLC, 400 SEVENTH STREET N.W., SUITE 600, WASHINGTON, DC, 20004, US

(21) Appl. No.: 10/311,348

(22) PCT Filed: Jun. 29, 2001
(86) PCT No.: PCT/GB01/02918

(30) Foreign Application Priority Data
Jul. 5, 2000 (GB) 0016479.8

(51) Int. Cl. B01D 65/00

(52) U.S. Cl. 204/516; 204/627

(57) ABSTRACT

An electrokinetic geosynthetic (EKG) structure comprising conductive geosynthetic material wherein the conducting geosynthetic material comprises an open mesh structure, and a method of consolidating a substrate and in particular a cohesive soil substrate using such a structure.

The present invention relates to an electrokinetic geosynthetic structure, the use of the electrokinetic geosynthetic structure as a drain and/or reinforcing member or the like, in particular to improve consolidation and reinforcement of a weak or soft substrate.

The use of geosynthetic materials for reinforcement or drainage purposes is established practice. The materials used are generally non-metallic and can take any form, the most common being strips, sheets and grids. They can be manufactured by any suitable method, such as knitting, weaving or needle punching. Geosynthetics, also known as and sometimes referred to as geotextiles, are typically referred to by their principle function for any particular application and since there are essentially five principle functions there are five types of geosynthetics. These are filtration, separation, membrane, drainage and in plane flow, and reinforcement geosynthetics.

Geosynthetics may also provide any combination of the above functions and the present invention can be used for all of these functions, but is particularly application for example in drainage and reinforcement of substrate material in the construction industry, and thus has numerous industrial applications. The invention is in one aspect primarily, but not exclusively, concerned with drainage and/or reinforcement geosynthetics, in particular, to improve consolidation and/or reinforcement of a substrate, and these purposes in particular are described in greater detail hereinafter.

Before buildings or the like can be constructed in an area, it is necessary that the ground upon which the construction is to take place is consolidated. This is especially true in relation to weak or soft soils having a high water content, for example cohesive soils such as clays. Good consolidation may also allow the construction of substrate structures using such weak or soft soils as fill.

Conventional drain structures have comprised an elongate plastics core, for example of geosynthetic material, typically surrounded by a filter material and/or support by a reinforcing material. The core material is configured, for example by provision of suitable corrugations or use of a mesh like structure, to define a series of elongate fluid channels. Water is free to pass through the filter and/or reinforcing materials into these corrugations. The ground may be consolidated by application of a surcharge load to force water through these channels. Similar considerations apply to vertical and horizontal drains.

GB 2 301 311 relates to improvements in geosynthetics and introduces electrokinetic geosynthetics (hereinafter referred to as EKGs). EKGs are electrically conductive geosynthetics or geotextiles, which offer enhanced performance over non-conductive geosynthetics. This prior art document discloses EKG structures including layers of drainage and reinforcement geosynthetics stitched together with conductive fibres. The reinforcement and/or drainage material may also be conductive.

EKGs, in addition to providing filtration, drainage and reinforcement can be enhanced by electrokinetic techniques for the transport of water and chemicals species within fine grained low permeability substrates, which are otherwise difficult or impossible to deal with. In addition to conductivity, transivity, absorption, wicking, hydrophilic and hydrophobic tendencies may also be incorporated in the geosynthetic.

The ability of electrokinetic phenomena to move water, charged particles and free ions through fine-grained low permeability substrate is established. There are five principle electro kinetic phenomena: streaming potential, migration potential, electro osmosis, ion migration and electrophoresis. The first two of these phenomena are concerned with the generation of electrical potential due to the movement of charges and charged particles respectively. The remaining three are concerned with the transport mechanisms developed upon application of an electrical field across a substrate mass.

In practice, an electrical field is applied across a substrate mass using EKG or conventional electrodes. Cations are attracted to the cathode and anions to the anode. The three transport mechanisms are explained below.

In electro-osmosis, as the ions migrate they carry their hydration water with them and exert a frictional force on the water around them. Hence, there is a flow of water at both the anode and the cathode. In order to maintain a charge neutrality however, there are more cations than anions in the pore fluid of the substrate containing negatively charged particles. Therefore there is a net flow of water to the cathode. This electro osmotic flow depends upon the applied voltage gradient and the electro osmotic permeability of the substrate.

The application of an electrical field across a substrate mass causes migration of the free ions and ion complexes, which are present within the pore fluid, to the appropriate electrode. The average mobility of ions in substrates may be of the order of 5×10⁻⁸ m/Vs, which is an order of magnitude greater than the electro osmotic permeability. Hence, anions can usually overcome the electro osmotic flow and migrate towards the anode; this movement being known as electro migration or ion migration.

When a DC electric field is applied across a particulate suspension, (colloids, clay particles, organics) charged particles in suspension are electrostatically attracted to one of the electrodes and are repelled from the other. Positively charged particles are attracted to the cathode and negatively charged particles are charged to the anode. Most colloids are negatively charged and are therefore attracted to the cathode. This electrophoresis has found applications in the densification of sludges and mine tailings.

There are a number of materials which can be used to produce electrically conductive geosynthetics, such as carbon materials, conductive composites, polymers and metals in the form of fibres, strips, wires, elements, stitching.

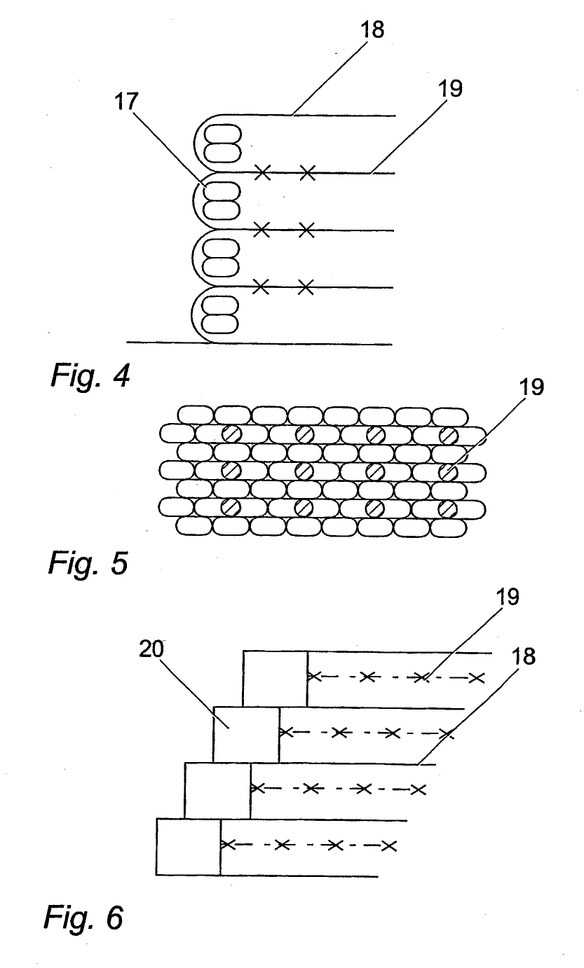

EKGs can take the form of single materials, which are electrically conductive, or composite materials, in which at least one element is electrically conductive, such that the EKG can function as an electrode. As described in GB 2301311 these are of the same basic form as present day filter, drainage, separator and reinforcement materials, but offer sufficient electrical conduction to allow the application of electro kinetic techniques for ground improvement. In particular, GB 2301311 proposes the use of EKGs as an alternative in reinforcing and/or drainage structures of familiar design, incorporating filter and/or reinforcing layers in a multi layer structure (for example to define and support a drainage channel) in the familiar manner (see for example FIG. 4c). Such layered designs, although suitable for many applications, can be limiting in some instances.

There is thus a need for an alternative EKG structure which is easy to manufacture, durable and has a wide variety of applications. This need is satisfied by the present invention.

According to a first aspect of the invention there is therefore provided an EKG structure comprising conductive geosynthetic material wherein the conducting geoysnthetic material comprises an open mesh structure.

The EKG structure thus consists essentially only of geosynthetic material in an open mesh structure optionally inherently conducting and/or ill association with one or more conducting elements (which may be integral to the open mesh structure as is described in more detail below). In particular, the EKG structure is not provided with a surrounding sheath such as is conventionally provided for filtration and/or protective purposes, nor does it incorporate further structural or supporting members such as might be conventionally used, for example, to help define or support open channels for drainage within the overall structure.

The invention relies instead upon the surprising discovery that these elements are not required where an electrically conductive geosynthetic material is used. For example, in relation to drainage applications, it has been surprisingly found that it is unnecessary to provide additional structural and/or filter members to ensure that the overall structure defines one or more drainage channels.

Whilst the invention is not limited to any particular theory, it appears that, with suitable selection of geosynthetic materials and application of a suitable field to the EKG structure, the effect is so enhanced that water can be driven through the substrate without the need for provision of explicit drainage channels within the EKG structure itself.

Thus, an EKG structure in accordance with this aspect of the invention makes use of the advantageous behaviour potentially offered by conducting geosynthetics for a range of applications as set out in GB 2301311, but with increased structural simplicity. For example the EKG structure may be suited as at least one reinforcement and/or drainage/in plane flow. In particular, the EKG structure has application in improved consolidation and/or reinforcement of weak or soft substrates such as cohesive soils, for example in that it comprises a drainage means therefor.

The conducting geosynthetic material may have any suitable composition to give conductive properties. For example, the conductive geosynthetic material may comprise a generally inherently non-conductive geosynthetic in association with at least one conducting element to produce a composition conducting geosynthetic material. Alternatively, the geosynthetic material may be inherently conducting, for example by loading with conducting particles. Such inherently conducting geosynthetic material may additionally be associated with at least one separate conducting element, to provide a composite conducting geosynthetic.

Reference herein to substrate is to soil, loam, earth, sod and other ground material including mixed ground material and waste material or a mix of ground material and any other material, sewage, sludge, or other substance or mixture of substances to be treated.

Since no overall internal structure is required of an EKG according to the invention, the conductive geosynthetic mesh in a simple embodiment may comprise a generally planar mesh, with the EKG structure itself comprising one or more such planar meshes. Alternatively, the conductive geosynthetic mesh may be corrugated or may form an enclosing mesh structure defining any solid shape, such as a sphere, ellipsoid, parallelepiped, cube or cone. A particularly preferred structure is an open sleeve structure.

Such structures will be known to those skilled in the art. For example, it is known to provide corrugated or open sleeve meshed plastics materials to define water channels within a filter sleeve in a conventional vertical drain. In accordance with the present invention, filter sleeves and structural supports and reinforcements and the like are not present, and accordingly the conducting geosynthetic mesh structure will substantially collapse under pressure from the substrate mass in use in a substrate. Despite this it is unexpectedly found that some benefits are retained. In particular, it appears that enhanced drainage flow is maintained even when the structure has substantially collapsed, the vestiges of the structure providing discontinuities in the substrate which can serve as preferred fluid flow paths.

Suitable geosynthetic materials will be familiar to those skilled in the art. These will include polymer materials such as polyethylene, polypropylene, PVC, certain polyesters and the like. Geosynthetic materials may be made conducting by provision of separate conducting elements and/or by loading with conducting material, both options being described in more detail below.

One or more separate conducting elements may be provided in any conducting configuration comprised as or associated with the geosynthetic material, suitably chosen according to the desired application. Preferably the conducting element is suited for contact with the substrate or any other material to be treated, directly or indirectly via intermediate conducting medium. More preferably an immersed EKG comprises the conductive element associated with a face of the geosynthetic mesh in direct contact with substrate; or an enclosing mesh structure comprises the conductive element at an inner face thereof Additionally or alternatively, the geosynthetic mesh is inherently conducting and/or a conductive element is provided integral therewith.

An immersed EKG structure may have proximal and remote regions with respect to the substrate or material to be treated, and preferably comprises the conductive element associated with a proximal region, for example in a planar EKG, associated with a proximal face. Without being limited to this theory it is thought that this improves electrical continuity.

Any shape of the conducting element may be provided which creates a conducting EKG structure. For example, the conducting element may be in the form of a filament, fibre, strand, wire, layer of any shape or other solid or hollow form or otherwise, for example, adapted to conform to the structure or environment.

Where a plurality of conducting elements are provided, these may be positioned in an arrangement within the EKG structure or within a part of the EKG structure. For example the conducting elements may be randomly, regularly or irregularly spaced. In one preferred embodiment the conducting elements are in the form of one or more lines of spaced preferably parallel elongate members, which preferably correspond to the elements of the geosynthetic mesh.

A conducting element may be provided separate from, but electrically associated with the geosynthetic mesh structure. However, for simplicity of construction in a preferred embodiment, the conducting member is preferably integral with the geosynthetic mesh structure. The conducting member may be of similar or dissimilar material to the mesh structure. For example the conducting member may be in direct contact with a surface thereof, being for example bonded, co-extruded, interwoven or interknitted with the mesh structure.

Additionally or alternatively, a conducting member may be provided internally to the mesh, enclosed in a geosynthetic outer layer. The geosynthetic outer layer provides environmental protection. The geosynthetic outer layer may also be inherently conducting. In a particularly preferred embodiment, each mesh string in the geosynthetic mesh structure comprises a conducting core preferably of metallic material, for example copper, overlain by conducting geosynthetic material.

The conducting element or elements in an EKG structure as hereinbefore defined may be provided in any known conducting material. For example, the conducting element may be pure or composite metallic such as metals or metal powders (steel, copper) dispersed in suitable solid carriers, or conducting non-metallic, such as carbon, a conducting polymer or composite thereof. In an EKG structure as hereinbefore defined in particular where the conducting element is associated with an external surface, the at least one conducting element preferably comprises conducting non-metallic material. Such material is, by definition, less prone to corrosion than metallic material. More preferably, the conducting element comprises conducting non-metallic polymeric material. Alternatively, in particular where the conducting element is integral with the conducting geosynthetic material, the conducting element comprises metallic material and is preferably wholly surrounded by a preferably conducting non-metallic geosynthetic outer layer.

The structure preferably comprises a suitable connection for connecting to an electrical supply. The connection may be any connection known in the art for connecting wires or for connecting a wire and conducting shaped electrode. Preferably the connection is insulated to prevent degradation by corrosion due to the presence of water, for example by immersing in resin or enclosing within an insulating box. Preferably a plurality of connections have similar electrical continuity and present similar resistance, ensuring uniform power and minimal potential loss over the electro osmosis system. This allows use of the structure as an electrode, to facilitate drainage and/or control of water content and/or consolidation of a substrate.

In a particularly preferred embodiment the EKG structure as hereinbefore defined is in the form of a continuous, elongate tube, tape or sleeve. Such EKG structures are easy to transport and position within substrate. They may be used in combination, for example in an array or grid. They may thus be used as a plurality of cathodes and/or anodes, or if in contact with each other, in combination as a single cathode and/or anode. The tape tube or sleeve may be given a mesh structure by any suitable fabrication route, such as weaving or knitting of overlapping mesh strings, co-extrusion, casting or injection moulding, perforation of sheet metal, etc.

The conducting geosynthetic mesh structure may be of any suitable open mesh network configuration. Preferably, the mesh structure is generally regular. For example, the mesh may comprise two series of parallel geosynthetic mesh strings overlapping to produce a rhombic network structure. Alternatively, individual network mesh strings may be arrayed to produce a hexagonal net structure. Alternatively, the mesh structure may be formed by a preferably regular array of perforations in a geosynthetic sheet. Other structures will readily suggest themselves to the skilled person.

The conductive geosynthetic mesh may be manufactured by any conventional method and may be rendered electrically conductive, for example by applying a conducting element by heat bonding, gluing, needle punching, extrusion, extraction, casting, moulding, weaving, knitting or any combination of these methods. Additionally or alternatively, the geosynthetic mesh may be rendered electrically conductive by making the geosynthetic material conductive, for example by loading with a conductor such as carbon black, carbon fibre, metallic fibres etc. The chosen method is dependent on the required properties of the mesh.

In a further aspect of the invention, there is provided a substrate structure comprising suitable structure retaining means, a substrate fill, and an EKG structure as hereinbefore described, and in particular a plural array thereof, disposed in the substrate to serve to drain and/or consolidate and/or regulate the water content thereof Conventionally, such structures have used non-cohesive fills. However, the present invention in a preferred embodiment utilises a cohesive soil substrate fill, such as a clay soil.

When an array of EKG structures are provided for drainage and/or consolidation and/or reinforcement of a substrate, whether in-situ or as part of a reinforced soil construction such as an embankment, any suitable orientation is used. An EKG structure may be disposed vertically (e.g. as a vertical drain) horizontally, or at any suitable angle.

In a further aspect of the invention there is provided the use of the EKG structure as hereinbefore defined as an electrode. In a preferred embodiment the EKG structure as hereinbefore defined is adapted to be used as both a cathode and an anode. This allows reversal of the electrical field in situ.

In a further aspect of the invention there is provided a method of treating a substrate by improving its consolidation and/or regulating water content and/or reinforcement comprising positioning a plurality of electrodes, at least one of which is an EKG structure as hereinbefore defined, in situ in the substrate and applying an electric field between at least a pair of the electrodes to remove water or regulate water content therebetween. In particular, there is provided a method of treating a cohesive soil structure to facilitate its use as a construction substrate by so positioning a plurality of electrodes and so applying an electric field. In a preferred embodiment, the method comprises inserting a plurality of EKG structures into a substrate, for example in a generally horizontal array, to define a plurality of consolidation zones, and successively applying an electric field between successive pairs to consolidate each zone sequentially. In this method the structure serves as either cathode or anode as necessary.

The EKG may be installed by any known technique into a surrounding substrate, for example by lancing the substrate or by rotary drilling or auger. The EKG may be installed directly into surrounding substrate or may be installed into a contact material which is installed or injected within the substrate. A suitable contact material is any material providing good electrical conductivity, for example any backfill such as clay, bentonite slurry and the like. The substrate may expand or contract during or after installation which may improve or reduce electrical contact and contact material may be injected accordingly as desired.

In a further aspect of the invention there is provided a method of treating a substrate by adding a nutrient or other biological or non-biological material, changing the pH or heating comprising providing a source of the material, positioning a plurality of electrodes, at least one of which is an EKG structure as hereinbefore defined in situ and applying an electric field between the electrodes.

An electric field for use with the EKG, electrode or in the methods of the invention may be uniform, stepped or otherwise profiled with time or throughout the electrode or EKG. Preferably the field is uniform throughout the structure and varies with time, for example is stepped up from an initial threshold field.

The methods may be used with any number of electrodes. Where more than two electrodes are provided, individual electrodes may be connected to electrical supplies and the electrical potential applied across each anode/cathode pair. Such connection is known as mono polar connection. One disadvantage of mono polar connection is the necessity for high current, low voltage supplies that are relatively expensive.

Alternatively and preferably, the outer two electrodes of an array of electrodes may be connected to an electrical supply. In this way the intermediate electrodes act as induced electrodes and the voltage distributes itself between the outer electrode pair. This is known as bi polar connection and simplifies electrical connection as well as requiring a lower current and higher voltage than mono-polar connections. The reduced current requirements will lead to lower current densities, which are desirable for efficient electro osmosis.

In a further aspect of the invention there is provided a treated substrate obtained by transformation of a core element or environment, with use of an EKG or method as hereinbefore defined. In particular there is provided a treated cohesive soil substrate for use as a structure.

In a further aspect of the invention there is provided the use of the EKG structure or method as hereinbefore defined as a drain to consolidate or regulate the water content of a substrate, and in particular a cohesive soil substrate, and/or to reinforce such a substrate and/or remove contaminants and/or to add a treatment material.

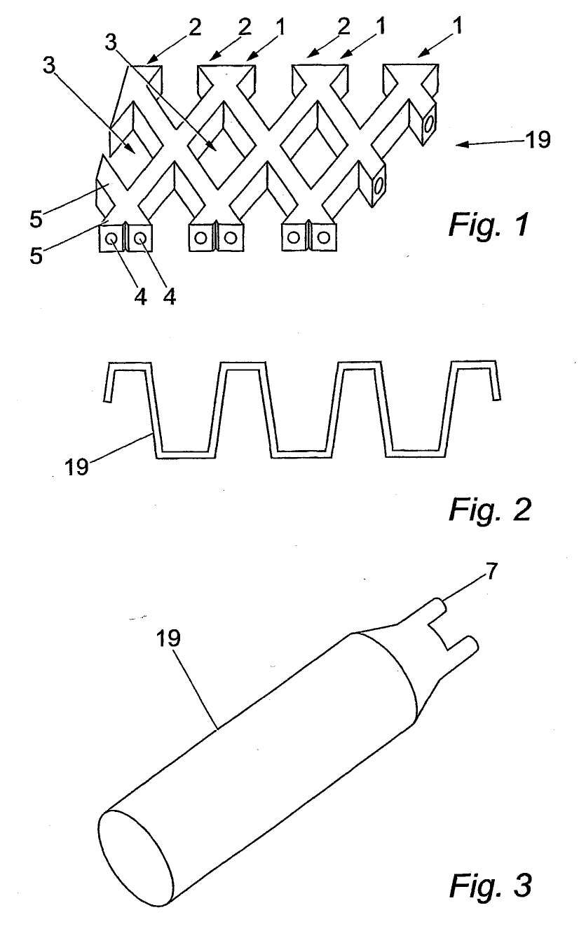

Embodiments of the invention will now be described by way of example only with reference to FIGS. 1 to 6.

FIG. 1 is an isometric view of the EKG material according to the invention.

FIG. 2 is a schematic end elevation of an EKG structure incorporating the material of FIG. 1.

FIG. 3 is a schematic isometric view of an alternative EKG structure incorporating the material of FIG. 1.

FIG. 4 is an EKG construction for reinforcement and consolidation of a substrate.

FIG. 5 is a front elevation of the EKG construction of FIG. 4.

FIG. 6 is an alternative EKG construction for similar purposes.

Referring to FIG. 1, a section of conducting geosynthetic mesh making up the EKG structure (19) is shown. The mesh comprises a first set of parallel EKG members (1) and a second set of parallel EKG members (2) overlapping and arrayed to produce a rhombic mesh with apertures (3). The material of the mesh comprises conducting core elements (4), which in this example are copper, enclosed in a conducting geosynthetic outer layer (5).

FIGS. 2 and 3 illustrate schematically possible configurations of EKG structure in accordance with the invention. In FIG. 2, the structure (19) is given a corrugated shape. In FIG. 3, the structure (19) has an open sleeve shape and is shown with a connector (7) to facilitate its use as an electrode. It is a particular advantage of the invention that the use of EKG material so enhances the consolidating effect that structure is not necessary, and accordingly no additional structural supports are provided to maintain the mesh shape. In consequence, the structure essentially collapses and/or substrate in any case passes through the apertures (3) when the structure is inserted into the substrate. Nevertheless, giving the mesh some three dimensional structure can produce enhanced effects, apparently in that the vestiges of the structure which remain in the collapsed state still serve as discontinuities and hence potential drainage paths within the substrate.

FIG. 4 shows a concertina construction of reinforced soil using sandbags (17) grouped vertically by a reinforcing member (18) comprising stabilising tape, grid or sheet, with the use of EKG elements (19). In this EKG concertina construction, each layer of EKG can act as both anode and cathode. Each layer is activated in turn as construction proceeds to drain liquid from the reinforcing construction. The EKG elements here additionally serve as reinforcing members but may alternatively be separate from reinforcing members, in similar fashion to that illustrated in FIG. 17.

The construction has both drainage and reinforcement properties and therefore facilitates the use of a substrate such as a cohesive soil in building up the overall construction of reinforced soil. The construction is built up layer by layer, and since each layer of EKG can act as both anode and cathode this permits each layer to be consolidated in term. By utilising the electro osmotic effects thereby generated, consolidation of the soil is achieved similarly layer by layer without the need for application of a surcharge load.

FIG. 5 is a front elevation of the EKG concertina construction showing positioning of the EKGs.

FIG. 6 shows an alternative reinforcement construction using gabions (20) and EKG members (19) separate from conventional reinforcing members (18).

Further advantages of the invention will be apparent from the foregoing. Further applications of the invention will be apparent to the skilled person by analogy with applications for prior art geosynthetic structures, and in particular for prior art EKG structures such as are described in GB 2301311.

1. An electrokinetic (EKG) drainage structure comprising conducting geosynthetic material wherein the conducting geoysnthetic material comprises an open mesh structure, and wherein the EKG drainage structure is not provided with a surrounding sheath or with further structural or supporting members defining open drainage channels.

2. An EKG structure in accordance with claim 1 consisting essentially only of geosynthetic material in an open mesh structure which is inherently conducting and/or in association with one or more conducting elements

3. An EKG structure in accordance with claim 1 or claim 2 wherein the conducting geosynthetic material comprises a generally inherently non-conductive geosynthetic in association with at least one conducting element to produce a composition conducting geosynthetic material.

4. An EKG structure in accordance with claim 1 or claim 2 wherein the geosynthetic material is inherently conducting.

5. An EKG structure in accordance with claim 4 wherein the geosynthetic material is inherently conducting by being loaded with conducting particles.

6. An EKG structure in accordance with claim 4 or claim 5 wherein the inherently conducting geosynthetic material is additionally associated with at least one separate conducting element, to provide a composite conducting geosynthetic.

7. An EKG structure in accordance with any preceding claim wherein the conductive geosynthetic mesh comprises a generally planar mesh.

8. An EKG structure in accordance with any of claims 1 to 6 wherein the conductive geosynthetic mesh comprises an enclosing mesh structure defining any solid shape.

9. An EKG structure in accordance with claim 8 wherein the conductive geosynthetic mesh forms an open sleeve structure.

10. An EKG structure in accordance with any preceding claim wherein the geosynthetic material is selected from polyethylene, polypropylene, PVC, polyesters and the like.

11. An EKG structure in accordance with any preceding claim wherein the geosynthetic material is made conducting by loading with conducting material.

12. An EKG structure in accordance with any preceding claim wherein the geosynthetic material is made conducting by provision of one or more separate conducting elements.

13. An EKG structure in accordance with claim 12 wherein the conducting element is positioned so as to be in use in an immersed EKG associated with a face of the geosynthetic mesh in direct contact with substrate.

14. An EKG structure in accordance with claim 13 wherein the conductive geosynthetic mesh comprises an enclosing mesh structure defining an open sleeve such that the conductive element lies at an inner face thereof.

15. An EKG structure in accordance with any one of claims 12 to 14 in use immersed having proximal and remote regions with respect to the substrate or material to be treated and comprising the conductive element associated with a proximal region.

16. An EKG structure in accordance with any one of claims 12 to 15 with a plurality of conducting elements in the form of one or more lines of spaced preferably parallel elongate members, which preferably correspond to the elements of the geosynthetic mesh.

17. An EKG structure in accordance with any one of claims 12 to 16 wherein the conducting element is integral with the geosynthetic mesh structure.

18. An EKG structure in accordance with any preceding claim wherein the mesh comprises two series of parallel geosynthetic mesh strings overlapping to produce a rhombic network structure.

19. An EKG structure in accordance with any one of claims 1 to 17 wherein the mesh comprises individual network mesh strings arrayed to produce a hexagonal net structure.

20. An EKG structure in accordance with any one of claims 1 to 17 wherein the mesh structure is formed by a regular array of perforations in a geosynthetic sheet.

21. A substrate structure comprising suitable structure retaining means, a substrate fill, and an EKG drainage structure in accordance with any preceding claim, and in particular a plural array thereof, disposed in the substrate to serve to drain and/or consolidate and/or regulate the water content thereof.

22. The use of the EKG drainage structure or method in accordance with any preceding claim as a drain to consolidate or regulate the water content of a substrate and in particular a cohesive soil substrate.
